(19) United States
(12) Patent Application Publication
(10) Pub. No.: US 2011/0172929 A1
(43) Pub. Date: Jul. 14, 2011

(54) SYSTEM AND METHOD FOR PREDICTION OF PHENOTYPICALLY RELEVANT GENES AND PERTURBATION TARGETS

(75) Inventor: Andrea Califano, New York, NY (US)

(73) Assignee: THE TRUSTEES OF COLUMBIA UNIVERSITY IN THE CITY OF, New York, NY (US)

(21) Appl. No.: 12/863,047

(22) PCT Filed: Jan. 16, 2009
(86) PCT No.: PCT/US2009/031314

§ 371 Date: Mar. 23, 2011

Related U.S. Application Data
(60) Provisional application No. 61/021,579, filed on Jan. 16, 2008.

(51) Int. Cl. G06F 19/00

(52) U.S. Cl. 702/20

(57) ABSTRACT

Disclosed herein is a systems biology approach to prediction of phenotypically relevant genes such as oncogenes and perturbation targets. Interactions from a comprehensive cellular network such as the B Cell Interactome (BCI) can be used to identify those that become affected, or dysregulated, by a phenotype (e.g, disease, tumor and cancer) or perturbation (e.g., drug treatment) based on correlation changes between expression profiles of gene pairs in the interactions upon removal or addition of samples showing the phenotype or perturbation. Genes can be ranked based on the affected interactions involving the genes to predict phenotypically relevant genes and/or perturbation targets.

### CROSS-REFERENCE TO RELATED APPLICATIONS

The present application claims priority to U.S. Provisional Application Ser. No. 61/021,579, filed Jan. 16, 2008, the entirety of the disclosure of which is explicitly incorporated by reference herein.

### STATEMENT REGARDING FEDERALLY SPONSORED RESEARCH

The invention was made with government support under by grants R01CA109755, R01AI066116, U54CA121852 and 5 T15 LM007079-15 awarded by the National Cancer Institute (NCI), the National Institute of Allergy and Infectious (NIAID), the National Centers for Biomedical Computing NIH Roadmap initiative, and the National Library of Medicine (NLM) Informatics Research Training Program, respectively. The government has certain rights in the invention.

### BACKGROUND

The disclosed subject matter relates generally to systems and methods for prediction of phenotypically relevant genes and perturbation targets.

High-throughput technologies are producing vast amounts of biological data, including gene expression and genotypic profiles, DNA-binding profiles from chromatin immunoprecipitation, genomic sequences, and protein abundance from mass spectrometry. This biological data has been used extensively to characterize the differences between cancer cells and their normal counterparts. Gene expression profiling, in particular, has been used in classifying tumors or patient prognosis based on specific molecular signatures, and characterizing the molecular signatures arising from specific pharmacological interventions in cells.

Recently a number of computational methods have been proposed for processing such biological data to identify oncogenes, tumor-suppressor genes, and even entire pathways that are dysregulated in cancer. Some methods focus on characteristics of individual genes or gene products. However, there exists a need for a technique for predicting phenotypically relevant genes and perturbation targets at a cellular network level.

### SUMMARY

The disclosed subject matter provides techniques for predicting phenotypically relevant genes and perturbation targets. The phenotype can be a disease (e.g., cancer or tumor). The genes can be oncogenes or tumor-suppressor genes. The perturbation targets can be drug targets.

In some embodiments of the disclosed subject matter, methods for predicting genes relevant to a phenotype are provided. The methods can include identifying interactions affected by a phenotype from a cellular network of interactions, ranking genes based on the statistical significance of the affected interactions involving the genes, and predicting phenotypically relevant genes based on the ranking.

In other embodiments of the disclosed subject matter, methods for predicting perturbation (e.g., drug) targets are provided. The methods can include identifying interactions affected by a perturbation from a cellular network of interactions, ranking genes based on the affected interactions involving the genes, and predicting perturbation targets (e.g., drug targets) based on the ranking.

The network can include protein-protein interactions, protein-DNA interactions and/or modulated interactions.

In other embodiments, correlation between expression profiles of two genes in an interaction from the cellular network can be determined in a sample. A sample refers to one or more samples. A sample which includes a phenotype or perturbation (e.g., drug) refers to one or more samples, in which there is at least one sample showing a phenotype or perturbation (e.g., drug). A sample which omits a phenotype or perturbation (e.g., drug) refers to one or more samples, in which there is no sample showing a phenotype or perturbation (e.g., drug). The correlation for an interaction can change from a sample which includes a phenotype or perturbation and a sample which omits a phenotype or perturbation. An interaction can show a loss of correlation (LoC) or a gain of correlation (GoC). An interaction having LoC or GoC can be affected by the phenotype or the perturbation.

In other embodiments, genes can be ranked using the Fisher's Exact Test. A value can be assigned to a gene involved in an affected interaction based on the number of interactions, the number of interactions involving the genes, the number of affected interactions, and the number of affected interactions involving the genes. The affected interactions can have a p-value less than a bonferroni-corrected threshold. The bonferroni-corrected threshold can be no greater than 0.1, for example, 0.005, 0.01, 0.05 and 0.1. Two or more genes can be ranked based on their respective assigned values.

In other embodiments, genes can be ranked using an Edge Set Enrichment Analysis (ESEA). A value can be assigned to a gene based on the correlation for the affected interactions involving the gene in a sample which includes the phenotype or perturbation and that in a sample which omits the phenotype or the perturbation. Two or more genes can be ranked based on their respective assigned values.

Genes having high ranking scores can be identified. These genes can be among top genes, for example, top 10, 20, 25, or 30 genes. These genes can be predicted as the phenotypically relevant genes or the perturbation targets.

In other embodiments of the disclosed subject matter, systems are provided to implement the methods for predicting phenotypically relevant genes or perturbation targets. The systems can include one or more processors and a computer readable medium coupled to the processor(s). The computer readable medium can store data such as interactions and expression profiles for gene pairs in the interactions. The computer readable medium can include instructions which when executed cause the processor(s) to identify interactions affected by a phenotype or perturbation; rank genes based on the affected interactions involving the genes; and predict phenotypically relevant genes and/or perturbation targets based on the ranking.

The accompanying drawings, which are incorporated and constitute part of this disclosure, illustrate preferred embodiments of the disclosed subject matter and serve to explain the principles of the disclosed subject matter.

### BRIEF DESCRIPTION OF THE DRAWINGS

FIG. 1(A)-(D) are functional diagrams illustrating an Interaction Dysregulation Enrichment Analysis (IDEA) according to some embodiments of the disclosed subject matter, with FIG. 1(A) showing network generation, FIG. 1(B) showing interaction analysis, FIG. 1(C) showing interactions a gene has in its neighborhood, and FIG. 1(D) showing gene enrichment analysis.

FIG. 2 is a diagram illustrating a method for predicting phenotypically relevant genes according to some embodiments of the disclosed subject matter.

FIG. 3 is a diagram illustrating a method for predicting perturbation targets according to some embodiments of the disclosed subject matter.

FIG. 4 is a system diagram illustrating a system for predicting a phenotypically relevant genes or perturbation targets according to some embodiments of the disclosed subject matter.

FIG. 5 is a cancer barcode according to some embodiments of the disclosed subject matter.

FIG. 6 is a Burkitt lymphoma module according to some embodiments of the disclosed subject matter.

### DETAILED DESCRIPTION

The disclosed subject matter provides a systems biology approach for predicting phenotypically relevant genes and perturbation targets. The Interactome Dysregulation Enrichment Analysis (IDEA), a cellular network-based approach, can be used to characterize oncogenic mechanisms and pharmacological interventions in, for example, B cells. Interactions from a comprehensive cellular network can be used to identify those that become affected by a specific phenotype or perturbation. Genes can be ranked based on the affected interactions involving the genes to predict phenotypically relevant genes or perturbation targets.

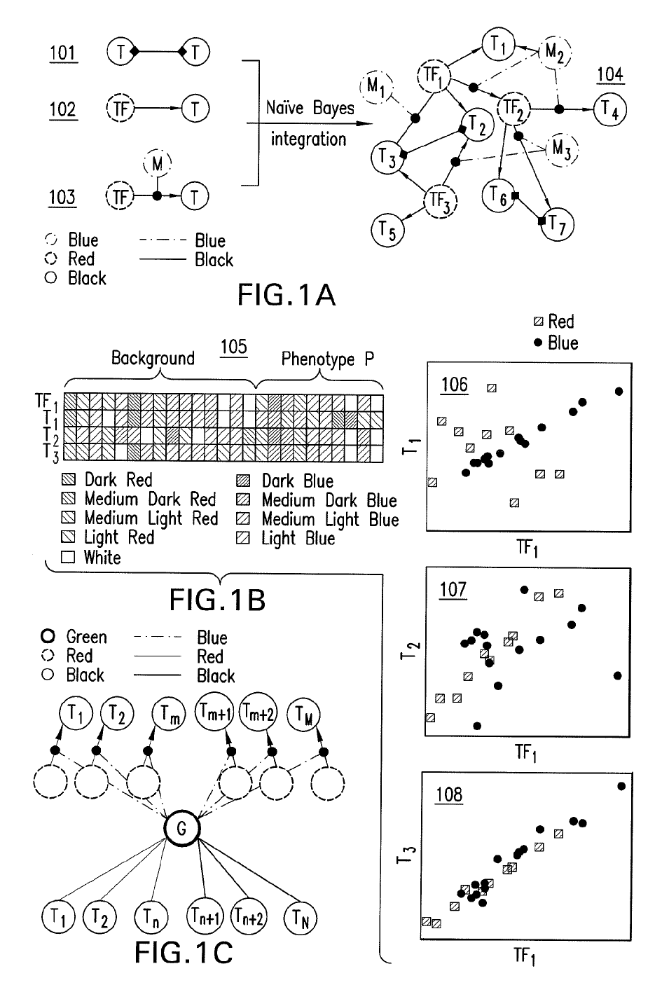

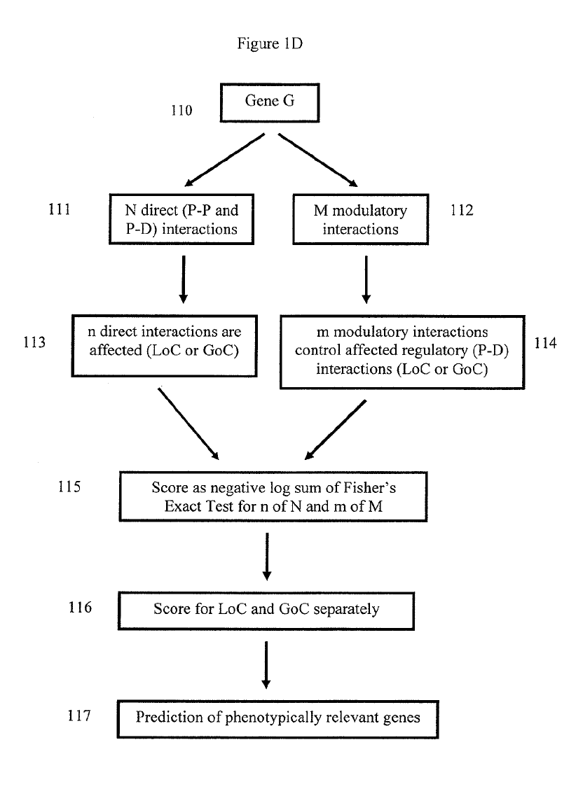

FIGS. 1(A)-(D) are functional diagrams illustrating a process in accordance with some embodiments of the disclosed subject matter. Protein-protein (P-P) interaction clues 101, protein-DNA (P-D) interaction clues 102 and modulatory interaction clues 103 can be integrated using a Bayesian evidence integration approach to generate a B-cell interactome (BCI) 104. Transcription factors (TF), non-transcription factors (T) and modulators (M) are shown in red, gray, and blue, respectively. Directed arrows indicate protein-DNA interactions, and undirected indicate protein-protein interactions or modulation events. Curated databases, literature mining, orthologous interactions from model organisms, and reverse engineering algorithms can be used as evidences or clues.

BCI interactions can be used to identify which interactions show a gain or loss of correlation pattern in a specific phenotype (P). At 105, interactions between a transcription factor (TF1) and its three targets (T1, T2 and T3) are analyzed to determine which show aberrant behavior in a specific phenotype (P) based on correlation between the expression profiles of these genes in samples not showing P (“background samples”), and samples showing P (“P samples”); that is, interactions that show a change of correlation pattern upon removal of P samples leaving only background samples. Scatter plots of the expression profiles of the gene pairs show a loss-of-correlation (LoC) pattern for the TF1-T1 interaction 106, a gain-of-correlation (GoC) pattern for the TF1 and T2 interaction 107, and no change for the TF1 and T3 interaction 108 upon removal of P samples. Background samples and P samples are represented by blue and red spots, respectively. Interactions having a LoC or GoC pattern are affected by the phenotype.

Genes involved in the BCI interactions can be ranked by pooling together all affected interactions genes have in their neighborhood, and calculating a statistical enrichment to identify which genes have an unusually high number of affected interactions. In its neighborhood 109, Gene (G) have normal, affected and modulatory interactions, which are shown in black, red and blue, respectively. At 110, G has N direct (P-P and P-D) interactions 111 and M modulated interactions 112. At 113, n of the N direct interactions can be affected (LoC or GoC). At 114, m of the modulatory interactions can control affected regulatory (P-D) interactions (LoC or GoC). At 115, G can be scored as negative log sum of the Fisher's Exact Test for n of N and m of M. At 116, G can be scored for LoC and GoC interactions separately. At 117, phenotypically relevant genes are predicted based on the ranking.

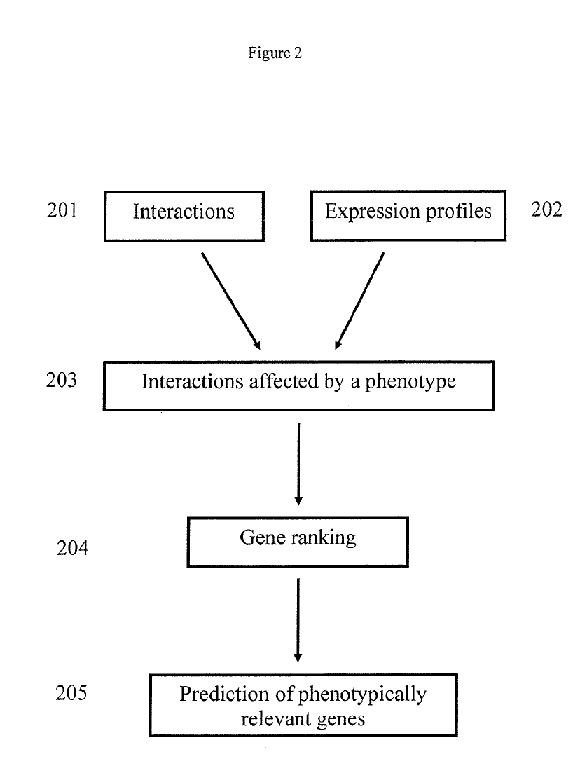

According to some aspects of the disclosed subject matter, a method for predicting a phenotypically relevant gene is provided. FIG. 2 is a diagram illustrating this method based on the IDEA. At 201, interactions from a cellular network can be provided. At 202, expression profiles of gene pairs in the interactions can be provided. At 203, interactions can be analyzed based on correlation between expression profiles of gene pairs to identify those interactions that become affected by a specific phenotype; that is interactions showing a LoC or GoC pattern upon removal or addition of samples showing the phenotype. At 204, genes can be ranked based on the statistical significance of the affected interactions involving the genes. At 205, phenotypically relevant genes are predicted based on the ranking. The phenotype can be a cancer or tumor. The predicted phenotypically relevant gene can be an oncogene or tumor suppressor gene.

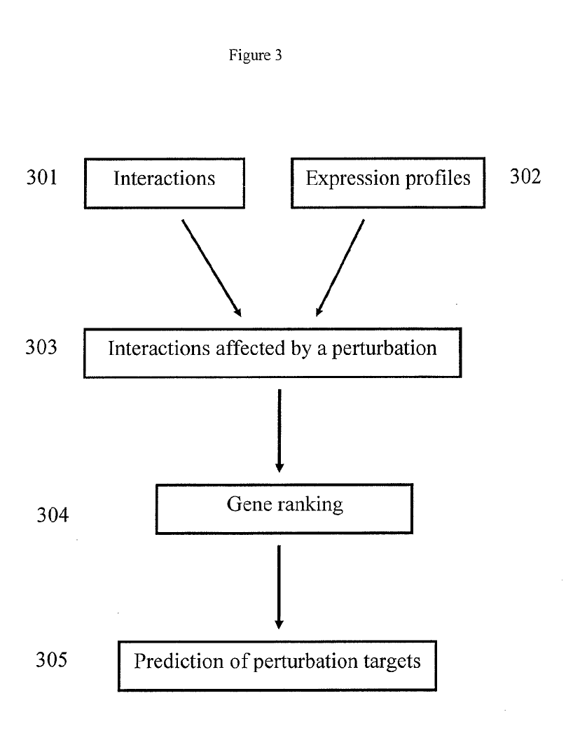

According to some aspects of the disclosed subject matter, a method for predicting a perturbation target is provided. FIG. 3 is a diagram illustrating this method based on the IDEA. At 301, interactions from a cellular network can be provided. At 302, expression profiles of gene pairs in the interactions can be provided. At 303, interactions can be analyzed based on correlation between expression profiles of gene pairs to identify those interactions that become affected by a specific perturbation; that is interactions showing a LoC or GoC pattern upon removal or addition of perturbed samples. At 304, genes can be ranked based on the statistical significance of affected interactions involving the genes. At 305, perturbation targets are predicted based on the ranking. The perturbation can be a drug treatment. The perturbation target can be a drug target.

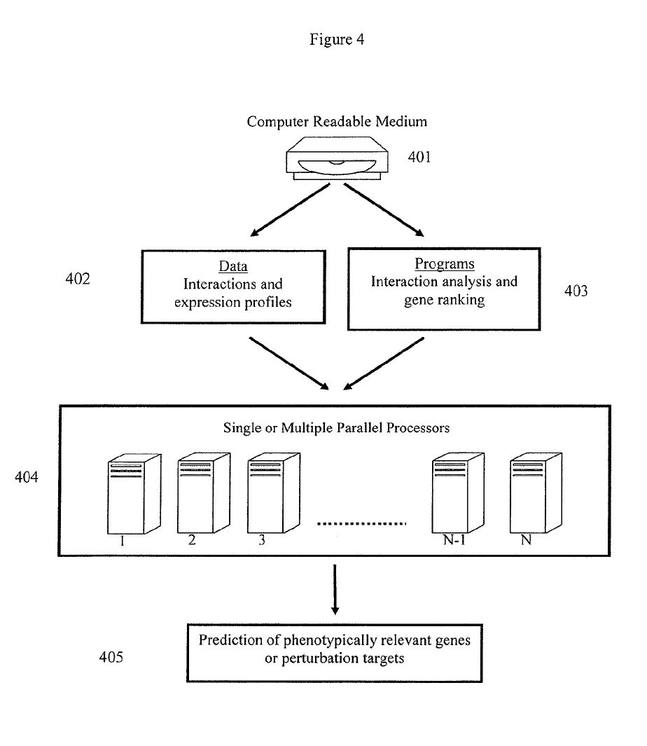

The techniques of the disclosed subject matter can be implemented by way of off-the-shelf software such as MATLAB, JAVA, C++, or other software. Machine language or other low level languages can also be utilized. Multiple processors working in parallel can also be utilized. As illustrated in the embodiment depicted in FIG. 4, a system in accordance with the disclosed subject matter can include a processor or multiple processors 404 and a computer readable medium 401 coupled to the processor or processors 404. At 402, the computer readable medium can include data such as interactions from a cellular network of interactions and expression profiles of gene pairs in the interactions. At 403, the computer readable medium can include programs for interaction analysis and gene ranking. At 405, the system leads to the prediction of phenotypically relevant genes or perturbation targets.

For clarity of description, and not by way of limitation, the disclosed subject matter is explained in details in the following subsections:

A. Network generation;

B. Interaction analysis;

C. Gene ranking; and

D. Perturbation targets.

### A. Network Generation

A cellular network of interactions can be a genome-wide, mixed-interaction network representing underlying interactions such as physical interactions between gene products (mRNA or protein), reactions between enzymes and their substrates, and metabolism of compounds. The interactions can include protein-protein (P-P) interactions, protein-DNA (P-D) interactions and modulated interactions.

These interactions can be predicted by applying a Naïve Bayes classification (NBC) algorithm to a variety of sources and gold-standard positive (GSP) and gold-standard negative (GSN) sets. The GSN is defined as gene pairs involving proteins in different cellular compartments. The negative pairs involving genes from the GSP can be extracted.

A P-P interaction represents a physical link between two proteins. Such a link can be a stable link (e.g., in a complex of proteins) or a transient contact (e.g., a kinase acting on a target protein to transfer a phosphate group to the target protein). Evidence for P-P interactions can be integrated from a number of sources, including databases HPRD (Peri et al., 2003 Genome Res. 13:2363-71), IntAct (Hermjakob et al., 2004 Nucleic Acids Res. 32:D452-55), BIND (Bader et al., 2003 Nucleic Acids Res. 31:248-50) and MIPS (Mewes et al., 2006 Nucleic Acids Res. 34:D169-72); human high-throughput screens (Ewing et al., 2007 Mol. Syst. Biol. 3:89; Rual et al., 2005 Nature 437:1173-78; Stelzl et al., 2005 Cell 122:957-68); GeneWays literature data mining algorithm (Rzhetsky et al., 2004 Genome Res. 13:2498-504); Gene Ontology (GO) biological process annotations (Ashburner et al., 2000 Nat. Genet. 25:25-29); gene co-expression data from B cell expression profiles (Basso et al., 2005 Nat. Genet. 37:382-90); and Interpro protein domain annotations (Mulder et al., 2007 Nucleic Acids Res. 35:D224-28).

A P-D interaction represents a physical link between a transcription factor (TF) and a DNA. Such a link can reflect the capability of the transcription factor to bind a promoter, enhancer or silencer region of its target gene, thereby affecting its expression level. Evidence for P-D interactions can be integrated from a number of sources, including mouse interactions from the databases TRANSFAC Professional and BIND; human P-D interactions inferred by the algorithms ARACNe and MINDy (Wang et al., 2006 Science 3909:348-62); transcription factor binding sites identified in the promoter of target genes (Smith et al., 2006 Proc. Natl. Acad. Sci. U.S.A. 103:6275-80); target gene conditional co-expression based on the B cell expression profiles and GSP interactions.

For P-P interactions and P-D interactions, a likelihood ratio (LR) for each evidence source can be generated using the GSP and GSN sets. Individual LRs can then be combined into a global LR for each interaction. A threshold corresponding to a posterior probability p≧50% can be used to qualify interactions as being present.

A modulated interaction represents an interaction that has multivariate dependence and is beyond a pair-wise paradigm. The MINDy algorithm can be used to predict post-translational modulation events, where a TF and its target appear to only have an interaction in the presence or absence of a third modulator gene (M). For example, a TF needs to be activated by a kinase in order to effectively regulate its target genes. These 3-way interactions can be split into two distinct pairwise interactions: a P-D interaction between the TF and its target and a TF-modulator interaction that can be either a P-TF or a TF-TF interaction, depending on whether the modulator is a TF as well. These interactions can be classified according to the number of target(s) a modulator affects for a single TF. A threshold can be set to include only modulated interactions involving modulators that affect, for example, 15 or more targets per TF.

The network can be filtered to contain only interactions involving genes expressed in samples showing a phenotype of interest. The samples can be tissues or cells isolated from organisms or cultured in vitro. A phenotype is a biological state, which can be, for example, a normal, disease (e.g., cancer and tumor) or perturbed state. While the NBC can be trained with all the genes, the output can be filtered for genes expressed in the samples showing a phenotype of interest. For example, B cell expression data can be used to filter for interactions involving genes expressed in B cells where the phenotype of interest is a B cell lymphoma.

### B. Interaction Analysis

Interactions in a cellular network can be analyzed to identify those that are affected by a phenotype. This analysis can be accomplished based on correlation changes between expression profiles of gene pairs in the interactions upon removal or addition of samples showing phenotype of interest.

The interactions can be split into all possible probe set pairs, resulting in a probe-based network of non-unique interactions. The probe-based network can be analyzed to determine correlation between expression profiles of gene pairs in the interactions by calculating pairwise mutual information (MI) across all interactions. MI is an information theoretic measure of statistical dependence, which can be zero if and only if two variables are statistically independent.

For a non-unique interaction, MI can be determined between expression profiles of two genes in the interaction in one or more samples using Gaussian kernel estimation (Margolin, et al., 2006 BMC Bioinformatics 7 Suppl. 1:S1-7) before and after removal of one or more samples showing a phenotype of interest. A sample not showing the phenotype, or background samples, can be related to a sample showing the phenotype. For example, an MI change (ΔI) corresponding to a correlation change can be defined in equation (1):

ΔI=MI_{All}[x;y]−MI_{All-P}[x;y] (1)

MI_{All}[x,y] is the MI between x and y estimated from a sample which includes a phenotype while MI_{All-P}[x;y] is the MI estimated from a sample which omits a phenotype. A sample refers to one or more samples. A sample which includes a phenotype or perturbation (e.g., drug) refers to one or more samples, in which there is at least one sample showing a phenotype or perturbation (e.g., drug). A sample which omits a phenotype or perturbation (e.g., drug) refers to one or more samples, in which there is no sample showing a phenotype or perturbation (e.g., drug).

The raw ΔI values are normalized according to, for example, two factors—the original strength of the interactions between gene pairs and the number of samples showing a phenotype P that can be removed (or the percentage of the overall background population they represent). A null distribution can be generated by sampling interactions from the network across the full range of MI. For this set of interactions, sample sets of size P (corresponding to the size of every phenotype being analyzed) can be taken out randomly from the dataset and the ΔI values can be computed across many trials. These null values can be used to estimate the significance of ΔI values computed for real phenotypic sample sets.

For each phenotype (P), an interaction can be classified as either a gain-of-correlation (GoC), loss-of-correlation (LoC) or no change (NC) interaction. An interaction having a positive ΔI value (i.e., the MI decreases upon removal of P samples) can be a GoC interaction while an interaction having a negative ΔI value (i.e., the MI increases upon removal P samples) can be a LoC interaction. The GoC or LoC interactions can be interactions affected by the phenotype.

### C. Gene Ranking

Genes can be ranked based on the affected interactions involving the genes to predict as phenotypically relevant genes. These genes can have high ranking scores. Genes having high ranking scores can be among top genes (e.g., top 10, 20, 25, and 30 genes).

Two enrichment approaches can be used to rank genes. Enrichment can reflect the degree to which a set of interactions (e.g., the affected interactions involving a specific gene) is overrepresented at the extreme (top or bottom) of the entire ranked list of interactions (e.g., affected interactions).

One approach can be based on the Fisher Exact Test (FET). Affected interactions that are significant can be considered. For each phenotype, an interaction having a p-value less than a bonferroni-corrected threshold can be significant. The bonferroni-corrected threshold can be no greater than 0.1 (e.g., 0.005, 0.01, 0.05 and 0.1). The number of significant interactions can be tallied for each gene. This enrichment can be computed in two ways, by separating GoC and LoC interactions, or counting them together. Modulated interactions can be added in during this step. A gene's natural connectivity can be measured by its direct connections as well as its modulated connections, i.e., the number of interactions involving the gene. A gene can increase its tally for significant interactions if it is also a modulator in the interactions.

Enrichment for each gene can be calculated using a set of hypergeometric tests. A Fisher Exact Test can be computed for each gene based on four (4) values. In the case of overall enrichment (no split between LoC and GoC), the values used can be the total number of interactions (N), the total number of interactions involving the gene (H), the size of the overall significant LoC or GoC interactions for that particular phenotype (S), and the number of significant LoC or GoC interactions involving the gene (D). This relation is illustrated in equation (2):

$$p - value ( G ) = 1 - {\int }_{i = 1}^{D - 1} \frac{( \begin{matrix}H \\ i\end{matrix} ) ( \begin{matrix}N - H \\ S - i\end{matrix} )}{( \begin{matrix}N \\ S\end{matrix} )} \qquad ( 2 )$$

Enrichment can be split between LoC and GoC, and equation (2) can stay the same, but the values plugged in can be split. N becomes total interactions showing any GoC or LoC pattern (significant or not), H is the total number of interactions around the gene that show any GoC or LoC pattern (significant or not), and D and S do not change. In the split case, two p-values can be generated and combined as a negative log-sum operation, producing a positive value. If p-values of zero are encountered, the resulting log operation will produce a score of Inf. The hypergeometric statistic can be computed such that those values can be ranked.

Enrichment can be split between interactions to which a gene is directly connected and interactions that the gene modulates. A set of four p-values can be generated according to equation (2) taking into consideration that a direct or modulated interaction can show a LoC or GoC pattern. These 4 p-values can be combined in a negative log sum operation.

Another approach is the Edge Set Enrichment Analysis (ESEA). The ESEA is derived from the Gene Set Enrichment Analysis (GSEA) (Subramanian et al, 2005 Proc. Natl. Acad. Sci. U.S.A. 102:15545-50). Like the GSEA works on genes, the ESEA works on interactions, also called edges. The ESEA can have general applicability, and can be used to account for enrichment of gene sets, gene categories, pathways, and other biological effects.

In the ESEA, the N interactions in the network can be ranked to form a ranked list L={jₜ, . . . , j_{N}} according to the normalized ΔI between expression profiles of gene pairs in the interactions upon removal of samples showing a phenotype. The ranked list L for each phenotype can be in the order of from highest gain-of-correlation to highest loss-of-correlation. For a given gene, a “hit” can be any affected interaction involving the gene (A), and a “miss” can be any affected interaction involving the gene. An interaction involving a gene can be an interaction in which the gene participates or of which it is modulates. The fraction of the hits weighted by their correlation and the fraction of the miss present up to a given position i in L can be evaluated. The enrichment score (ES) can be the maximum deviation from zero of Pₕᵢₜ-Pₘᵢₛₛ. Genes can be ranked based on GoC and LoC interactions separately as shown in Equations (3).

$${P}_{hit} = {\sum }_{j ∈ A} \frac{{d ( {g}_{i} , j )}^{- k} {\vert Δ I \vert}^{p}}{{N}_{{g}_{i}}} \\ {P}_{miss} = {\sum }_{j ∈ A} \frac{1}{N - {N}_{{g}_{i}}} \\ {ES}_{GOC} ( {g}_{i} ) = {max}_{GOC} ( {P}_{hit} - {P}_{miss} ) \\ {ES}_{LOC} ( {g}_{i} ) = {max}_{LOC} ( {P}_{hit} - {P}_{miss} ) \qquad ( 3 )$$

Equations (3) are nearly identical to those of the GSEA except one quantity. The distance (d) value appearing in the numerator can integrate network distance into the analysis. Direct links can be of distance 1 and d can take on increasing integer values corresponding to the number of hops a gene is from that interaction. The distance can also be weighted down by a factor (k). If k is 2, for instance, a hit of distance 2 would only be counted for ¼ of its actual value.

In adding network connectivity to the ESEA, it can be important to consider the biological scenarios where this propagation makes sense. For instance, effects of dysregulation can be observed downstream of an affected gene, but rarely upstream (barring feedback loops or other similar scenarios). For this reason, only upstream genes can be considered “neighbors” when calculating enrichment of affected interactions. This expansion can be limited to transcriptional interactions, as undirected or P-P interactions can be assumed to not be able to propagate influence.

A null distribution can be computed for the ES values in order to estimate the significance. This distribution can be computed by taking the unique set of hit counts for every gene and running random permutations of these hits across many trials. Each gene's ES score can therefore be normalized against a null distribution of its own connectivity. This distribution can become more complicated if the distance is taken into account. In this case, the unique set of first and second neighbors can be taken together, such that their proportion can be kept intact, but the rank in the edge list can be permuted.

One benefit of a network-based approach is that gene lists can be viewed in a network context. Top ranking genes in each phenotype can be used to create phenotype (e.g., disease) modules using, for example, the Cytoscape software package (Shannon et al, 2003 Genome Res. 13:2498-504). Phenotype modules can be compared. Diagrams of disease (e.g., cancer) modules can provide more cellular context than a ranked list of genes, and can effectively complement existing methods such as differential expression analysis. These module diagrams can also serve as a useful platform for further hypothesis generation and biochemical investigation.

Ranked genes can also be viewed in a network module to identify key regulators. Visualization of top ranking genes in a phenotype can be used to identify genes that control the vast majority of top ranked genes. These candidate driver genes can be experimentally validated using siRNA knockdowns or other perturbation assays.

The ranked gene lists can be further analyzed for enrichment in specific pathways. Genes that score high across multiple phenotypes can be identified pertaining to common mechanisms. When the scores across all phenotypes are averaged, top ranking genes can contain several key oncogenic regulators.

### D. Perturbation Targets

Samples in a perturbed state can be obtained by subjecting the samples, or the subjects from which the samples are obtained, to a pharmaceutical or biological intervention (e.g., drug treatment). A drug can be a pharmaceutical small molecule or a biological large molecule. Samples can also be perturbed by changing the growing conditions of the samples, or the subjects from which the samples are obtained.

Based on the network-based approach to predict a gene that is relevant to a phenotype of interest, perturbation targets (e.g., drug targets) can be predicted. The predication can be made using the same approach for predicting phenotypically relevant genes except that samples showing a specific phenotype are substituted with samples showing a specific perturbation or perturbed samples (e.g., drug-treated samples), and that the predicted genes can be perturbation targets (e.g., drug targets).

### EXAMPLES

The following examples merely illustrate some aspects of some embodiments of the disclosed subject matter. The scope of the disclosed subject matter is in no way limited by the embodiments exemplified herein.

### 1. Assembly of the B Cell Interactome

The B Cell Interactome (BCI) was assembled by including P-P interactions, P-D interactions and modulated interactions in a human B cell context.

A GSP for P-P interactions was generated using 27,568 human P-P interactions from HPRD (Peri et al., 2003 Genome Res. 13:2363-71), 4,430 from BIND (Bader et al., 2003 Nucleic Acids Res. 31:248-50), and 3,522 from IntAct (Hermjakob et al., 2004 Nucleic Acids Res. 32:D452-55), all originating from low-throughput, high quality experiments. The resultant GSP had 28,554 unique P-P interactions involving 7,826 genes (after homodimers removal). A GSN was generated to have 16,411,614 candidate non-interacting gene pairs. The negative pairs involving genes from the GSP were extracted, leaving 5,362,594 negative gene pairs.

The prior odds for a P-P interactions was approximately 1 in 800 based on previous estimates of the total number of P-P interactions in a human cell of ˜300,000 among 22,000 proteins (Hart et al., 2006 Genome 7:120; Rual et al., 2005 Nature 437:1173-78). From this value, any protein pair having an LR≧800, after evidence integration, had at least a 50% probability of being involved in a P-P interaction. Based on this threshold, the final set had 10,405 P-P interactions (2,677 genes) with a posterior probability P≧50% of being true interactions. All missing interactions in the GSP (10,765 interactions and 3,926 genes) were re-introduced.

To generate the GSP for P-D interactions, human interactions were extracted from the TRANSFAC Professional (Matys et al., 2003 Nucleic Acids Res. 31:374-78), BIND and Myc (MycDB) databases (Zeller et al., 2003 Genome Biol. 4:R69), selecting interactions involving genes expressed in B cells only. The resultant GSP P-D interaction set had 1,752 interactions involving 197 transcription factors (TFs) and 972 targets. For the GSN, a set of 100,000 random gene pairs was used, composed of a TF and a target, excluding pairs where the two genes were involved in a GSP interaction or in the same biological process in Gene Ontology. The GSP was split in two sets: one set of 1,116 interactions from the TRANSFAC Professional and Myc databases was used for training the NBC, and the remaining 636 interactions from the BIND and Myc databases were used for testing the performance of the classifier. Another random set of 24,000 interactions was created as a testing GSN set as described above and did not contain any interactions from the training GSN set. A TF-specific prior odds was used, as it had been previously demonstrated that the number of targets regulated by a TF could be approximated by a power-law distribution (Basso et al., 2005 Nat. Genet. 37:382-90; Yu et al., 2006 Genome Biol. 7:R55). Predictions by the ARACNe algorithm (Margolin et al., 2006 BMC Bioinformatics 7 Suppl 1:S1-7), an information-theoretic method for identifying transcriptional interactions between genes using microarray data, were used to approximate the expected number of targets for a single TF and compute the TF-specific prior odds.

The NBC produced a final set of 40,798 P-D interactions (303 TFs and 5,448 putative targets) with a posterior probability P≧50% of being true interactions. As with P-P interactions, all missing interactions from TRANSFAC Professional, BIND, and B cell Myc targets from the MycDB verified by a Chromatin Immunoprecipitation experiment were re-introduced (927 P-D interactions).

The modulated interactions were predicted using the MINDy algorithm, and split into two distinct pairwise interactions. These interactions were classified according to the number of target(s) a modulator affects for a single TF, and only modulators affecting 15 or more targets per TF were included (based on evidence from known modulator enrichment for MYC). This resultant set included 1,925 P-P interactions (of which 13 were supported by a direct P-P interaction as previously defined) involving 246 TFs and 430 modulators.

### 2. Analysis of the Interactions in the BCI

The interactions in an enhanced version of the BCI including 64,649 unique pairwise interactions (160,730 non-unique interactions between probes) were analyzed. The analysis used a large compendium of over 200 microarray expression profiles in B cells (BCGEP), including primary tissue as well as cell line samples, available in the NIH Gene Expression Omnibus (GSE2350). Samples in this set were hybridized to the Affymetrix HG-U95Av2 GeneChip®. After filtering for uninformative probes (those having less than a mean of 50 and a coefficient of variation less than 0.3 in the BCGEP), 7907 remained for analysis. Hierarchical clustering was performed to identify relatively homogeneous phenotype groups suitable for this analysis.

The analyzed phenotypes included Burkitt Lymphoma (BL), Follicular Lymphoma (FL), Mantle Cell Lymphoma (MCL), germinal center (GC), naive (N), memory (M), B cell chronic lymphocytic leukemia (B-CLL), B-CLL from mutated (B-CLL-mut) and unmutated (B-CLL-unmut) subsets, hairy cell leukemia (HCL), diffuse large B-cell lymphoma (DLCL), and primary effusion lymphoma (PEL).

Table 1 shows the number of affected interactions detected by the IDEA divided by LoC and GoC for each analyzed phenotype. A “p” preceding a phenotype name indicates those samples were purified.

TABLE 1
Distribution of phenotypes and LoC and GoC signatures

| Phenotype | No. of samples | LoC | GoC |
|---|---|---|---|
| B-CLL | 34 | 1813 | 10815 |
| B-CLL-mut | 18 | 121 | 3417 |
| B-CLL-unmut | 16 | 92 | 1430 |
| BL | 26 | 383 | 701 |
| pDLCL | 15 | 596 | 17 |
| pFL | 6 | 183 | 9 |
| HCL | 16 | 3399 | 824 |
| pMCL | 8 | 488 | 16 |
| PEL | 9 | 1839 | 1204 |

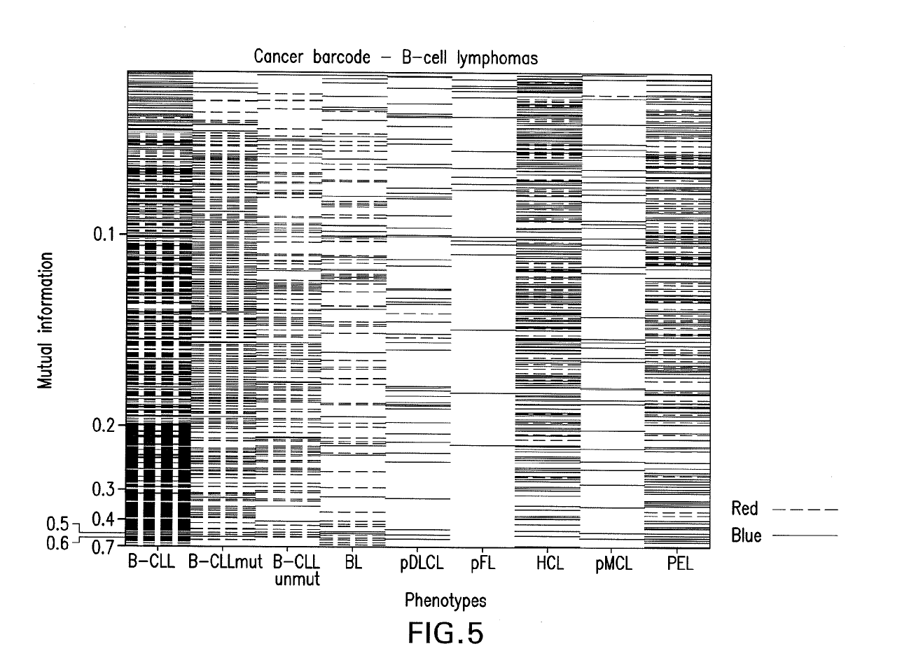

A complete set of the affected BCI interactions for each analyzed phenotype is presented as a “barcode” (FIG. 5). The rows represent these BCI interactions sorted in ascending order (from top to bottom) by their MI computed over the complete set of BCGEP samples. Each column is one analyzed phenotype. Interactions are color coded in blue for LoC and red for GoC. A large percentage of the network interactions were not affected by any of the phenotypes (80.5%), implying that many of the interactions represented a cellular network “backbone” that behaved consistently across phenotypes. Cancer barcodes for different phenotypes showed very distinct areas of the network, which could define their pathologic activity.

For the CD40 perturbation analysis, a set of 24 CD40-stimulated Ramos cell line samples was used against a background of 43 Ramos samples. The background included 28 untreated Ramos cell lines, as well as 15 treated with the IgM antibody, in order to provide some dynamic range to the dataset. The 24 CD40 samples included 6 that were treated with both CD40 and IgM, such that the effect of adding another perturbation was minimized.

The IDEA was benchmarked using three extensively characterized B-cell tumor phenotypes having oncogenes reported in the literature (BCL2 in FL; MYC in BL; and BCL1/CCND1 in MCL, respectively), and a set of biochemical perturbation assays (Examples 3-6). The normalized ΔI values were used. The FET enrichment was applied. The results were compared with those obtained by conventional differential expression analysis using a t-test. Each t-test was computed using log 2-transformed data and taking each phenotype against its normal counterpart (BL/GC, FL/GC, and MCL/N+M), applying Welch correction for sample sets of different size. The test results are summarized in Table 2.

TABLE 2
Comparative Ranks

| Phenotype | Gene | FET | Differential Expression |
|---|---|---|---|
| FL | BCL2 | 2 | 59 |
| BL | MYC | 10 | 34 |
| MCL | CCND1 | 10 | 8 |
| Ramos/CD40 | CD40 | 11 | 55 |

### 3. Follicular Lymphoma Benchmark

Follicular Lymphoma (FL) is one of the most common B-cell non-Hodgkin's lymphomas (NHLs). The key genetic lesion (found in 90% of FL samples) is the t(14; 18) rearrangement. This translocation causes the constitutive expression of the antiapoptotic BCL2 oncogene (Bende et al, 2007 Leukemia 21:18-29).

FL showed a relatively small network dysregulation signature, with only 86 LoC/GoC interactions. BCL2, which supports six of those interactions, was ranked second (see Table 2). By comparison, differential expression analysis ranked BCL2 in the 59th position (see Table 2).

Because of the extremely small signature, only eight genes were predicted as being significant, below a corrected value of 0.0004 (0.05 adjusted for the 126 genes that had any dysregulated signature).

### 4. Burkitt Lymphoma Benchmark

Burkitt Lymphoma (BL) is endemic among children in equatorial Africa and occurs sporadically in other geographic areas, where it also affects adults (Bellan et al, 2003 J. Clin. Pathol. 56:188-92). In these malignancies, a key oncogenic lesion is the translocation of the proto-oncogene MYC from chromosome 8 to either the immunoglobulin heavy-chain region on chromosome 14, or one of the light-chain regions on chromosome 2 or chromosome 22. MYC has been shown to have a global regulatory role in BL (Li et al, 2003 Proc. Natl. Acad. Sci. U.S.A. 100:8164-69).

MYC was found to be one of the most connected hubs in the BCI, having over 4000 probe-based interactions. Among them, 139 interactions were affected, giving this gene the 10th most significant enrichment score (see Table 2). By differential expression analysis between BL and GC cells (BL's normal counterpart), MYC was ranked 34th (see Table 2).

Other key effectors of MYC in BL were identified. MTA1, an established target of MYC, was ranked 17th, even though it was not even ranked in the top 1000 genes by differential expression.

A total of 82 significant genes were obtained using a cutoff of 0.05/930 (number of genes having any dysregulation signature).

### 5. Mantle Cell Lymphoma Benchmark

Mantle Cell Lymphoma (MCL) is an aggressive type of NHL that generally occurs in middle-aged and elderly people. Cyclin D1/BCL1 (CCND1) is a cell-cycle protein that is overexpressed in MCL as a result of the translocation t(11; 14) involving the immunoglobulin heavy-chain gene on chromosome 14 and a region on chromosome 11 harboring CCND1. (Miranda et al, 2000 Mod. Pathol. 13:1308-14).

In the BCI, cyclin D1 was connected to four dysregulated interactions, ranking it 10th (see Table 2). By differential expression analysis with non-GC samples (MCL's normal counterpart) CCND1 had a rank of eight (see Table 2). In addition, HDAC1 was ranked third among all candidates. HDAC1, which is highly differentially expressed, was ranked fourteenth by differential expression analysis.

Fourteen genes were identified as significant at a threshold of 0.05/241.

### 6. Biochemical Perturbation

The IDEA was run against Ramos cell line samples, where the CD40 signaling pathway had been biochemically perturbed (either by co-culturing with CD40-ligand producing fibroblasts, or using a CD40-specific antibody). Enrichment of the top 25 genes was calculated via a FET.

A total of 290 probes were ranked as having a non-zero score. Twelve of the CD40 pathway genes appearing in the list, many of them clustered at the very top. Remarkably, of the top 15 genes six were in the CD40 pathway set, including CD40 itself, which was ranked 11th (see Table 2). The other four CD40 pathway genes were NFKB1 (fifth), NFKBIA (13th), NFKBIE (third), NFKB2 (sixth), and TNFAIP3 (ninth), all known to be key effectors of CD40 signaling. As a score of zero was produced for all genes that did not participate in any affected interactions, it was not possible to analyze enrichment beyond these 290 probes.

These results were compared with differential expression analysis (same procedure, with CD40-stimulated against unstimulated). When compared with differential expression using the same cutoff of 379 probes, CD40 itself was ranked 55th (see Table 2), and no gene in the signature appeared until rank 32.

Furthermore, six CD40 pathway genes were identified in the top 25 genes (p-value=3.0063e-10 by FET) while only 0 of 25 were identified by differential expression analysis.

### 7. ESEA Enrichment

The ESEA was applied to the above benchmarks, using both modes (splitting into LoC/GoC) and combining them together. The ESEA performed comparably with the FET-based method. The results are summarized in Table 3.

TABLE 3
IDEA results using ESEA Enrichment

| | |
|---|---|
| ALL | SPLIT |

| | Rank | p-value | Rank | p-value |
|---|---|---|---|---|
| MYC | 1 | 0 | 5 | 0 |
| BCL2 | 22 | 0 | 36 | 7.8e−15 |
| CCND1 | 53 | 1.07e−6 | 54 | 2.5e−7 |
| CD40 | 34 | 2.12e−7 | 38 | 4.9e−8 |

### 8. Burkitt Lymphoma Module

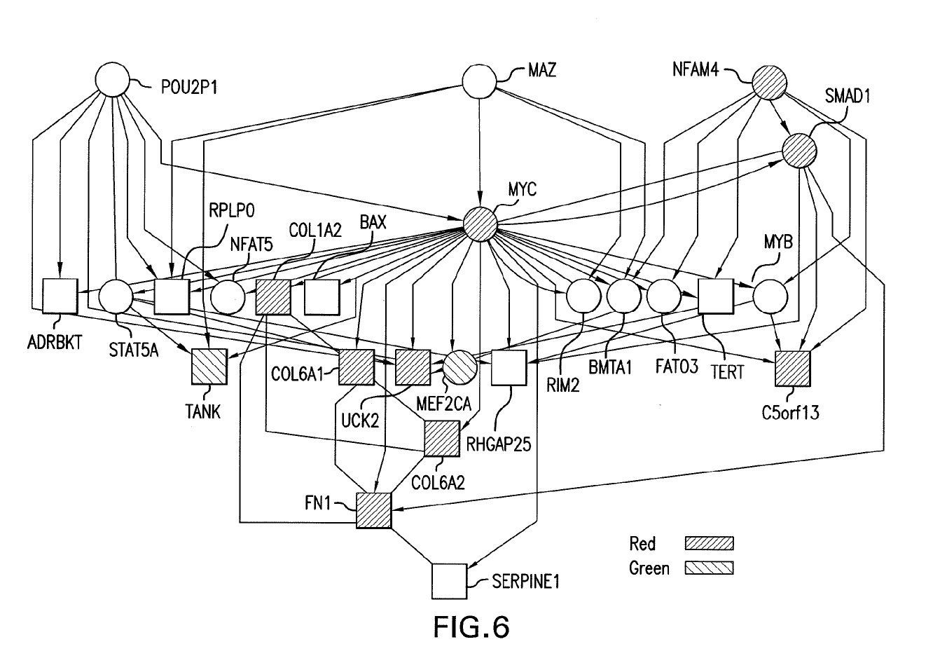

A network of the top 25 scoring genes in Burkitt Lymphoma (BL) is visualized in FIG. 6. Transcription factors are shown as circles, whereas other proteins are shown as squares. P-P interactions, P-D interactions and modulated interactions are shown in beige, black with an arrowhead, and blue with a circular endpoint, respectively. Red/green indicates overexpression or underexpression (p<1e-8), respectively, in BL versus GC cells.

### 9. Enrichment in Specific Pathways

For BL, the ranked output was compared to a set of Kyoto Encyclopedia of Genes and Genomes, or KEGG (Kanehisa et al, 2006 Nucleic. Acids Res. 34:D354-57), pathway annotations. The Focal Adhesion pathway (p=0) and the ECM-receptor interaction pathway (p=0) were identified. These two pathways contained similar sets of genes. Also identified were the B-cell receptor-signaling pathway (P=0.006) and the Jak-Stat-signaling pathway (P=0.057), which has been found relevant to several different cancer phenotypes.

When the scores across all phenotypes were averaged, the top scoring genes contained several key oncogenic regulators. Included in the top of this list were MYC, the tumor repressor PRDM2, JAK3, the transcriptional repressor DRAP1, and the estrogen receptor ESR1. Ranked second was the transcription factor POU6F1, which is known to have a role in several eukaryotic development processes, but has not been previously found relevant to lymphoma.

### 10. Analysis of Chronic Lymphocytic Leukemia

Chronic lymphocytic leukemia (CLL) is a complex tumor phenotype, for which oncogenic lesions have not been identified. There are five common chromosomal aberrations that have been associated with CLL: deletion of 17p13 (5-10%), deletion of 11q22-23 (10-20%), trisomy 12 (15-35%), deletion of 13q14 (55%), and deletion of 6q21 (6%). CLL develops out of early-stage B Cells and has two subsets, mutated and unmutated, which depend on the development stage of the cell of origin.

The top ranked IDEA genes included three in the chromosomal bands of interest: TRIM29 (11q23), RPAI (17p13.3) and MLL (11q23). Pathway enrichment of the ranked list against human KEGG database showed four highly enriched pathways—Cell Cycle, TGFβ signaling, Calcium signaling, and Neuroactive Ligand Receptor Interaction. Further, enrichment analysis of chromosomal bands showed a strong presence of genes in the 12p13 region, including CREBL2 and FOXM1. When the analysis was done separately for mutated and unmutated subsets of CLL, 23 of the top 50 genes in each set were common.

The top 25 genes formed a tightly connected cluster, with several of the genes not being significantly differentially expressed. From grouping the genes hierarchically, two seem to act as master regulators of the module—FOXM1 and STAT6. These genes both reside on chromosome 12 incidentally, and their identification by IDEA can indicate a more involved role in CLL.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within the spirit and scope of the disclosed subject matter.

What is claimed is:

1. A method for predicting at least one phenotypically relevant gene involved in one or more interactions affected by a phenotype from a cellular network of interactions, comprising:
(a) identifying one or more interactions affected by said phenotype;
(b) identifying at least two genes involved in said identified interactions;
(c) ranking each of said identified genes based on said identified interactions; and
(d) predicting said at least one phenotypically relevant gene based on said ranking.

2. The method of claim 1, further comprising:
(a) determining a first correlation between a predetermined expression profile for a first identified gene and a predetermined expression profile for a second identified gene from a sample which includes said phenotype;
(b) determining a second correlation between said predetermined expression profile for said first identified gene and said predetermined expression profile for said second identified gene from a second sample which omits said phenotype; and
(c) comparing said first correlation with said second correlation to determine a change of correlation.

3. The method of claim 1, said cellular network having a predetermined number of interactions, further comprising:
(a) determining a number of interactions which involve a first identified gene;
(b) determining a number of identified interactions involving said first identified gene;
(c) determining identified interactions having a p-value less than a bonferroni-corrected threshold; and
(d) assigning a value to said first identified gene based on said predetermined number of interactions, said determined number of interactions which involve said first gene, said identified interactions, said determined number of identified interactions involving said first gene, and said determined identified interactions having a p-value less than a bonferroni-corrected threshold.

4. The method of claim 3, further comprising:
(a) determining a number of interactions which involve a second identified gene;
(b) determining a number of identified interactions involving said second identified gene;
(c) assigning a value to said second identified gene based on said predetermined number of interactions, said determined number of interactions which involve said second gene, said identified interactions, said determined number of identified interactions involving said second gene, and said determined identified interactions having a p-value less than a bonferroni-corrected threshold; and
(d) ranking said first gene and said second gene based on said first gene value and said second gene value.

5. The method of claim 3, wherein said determining said number of identified interactions further comprises determining identified interactions having a loss of correlation.

6. The method of claim 3, wherein said determining said number of identified interactions further comprises determining identified interactions having a gain of correlation.

7. The method of claim 1, further comprising:
(a) determining a first correlation between a predetermined expression profile for a first identified gene and a predetermined expression profile for an identified gene that is not said first identified gene from a sample which includes said phenotype;
(b) determining a second correlation between said predetermined expression profile for said first identified gene and said predetermined expression profile for said identified gene that is not said first identified gene from a second sample which omits said phenotype; and
(c) assigning a value to said first identified gene based on said first correlation involving said first gene, said second correlation involving said first gene, and said identified interactions involving said first gene.

8. The method of claim 7, further comprising:
(a) determining a first correlation between a predetermined expression profile for a second identified gene and a predetermined expression profile for an identified gene that is not said second identified gene from a sample which includes said phenotype;
(b) determining a second correlation between said predetermined expression profile for said second identified gene and said predetermined expression profile for said identified gene that is not said second identified gene from a second sample which omits said phenotype;
(c) assigning a value to said second identified gene based on said first correlation involving said second gene, said second correlation involving said second gene, and said identified interactions involving said second gene; and
(d) ranking said first gene and said second gene based on said first gene value and said second gene value.

9. The method of claim 1, further comprising identifying at least one said identified gene having a high ranking score.

10. The method of claim 1, said cellular network comprising protein-protein interactions, protein-DNA interactions and modulated interactions.

11. A method for predicting at least one drug target corresponding to one or more interactions affected by a drug from a cellular network of interactions, comprising
(a) identifying one or more interactions affected by said drug;
(b) identifying at least two genes involved in said identified interactions;
(c) ranking each of said identified genes based on said identified interactions; and
(d) predicting said at least one drug target based on said ranking.

12. The method of claim 11, further comprising:
(a) determining a first correlation between a predetermined expression profile for a first identified gene and a predetermined expression profile for a second identified gene from a sample which includes said drug;
(b) determining a second correlation between said predetermined expression profile for said first identified gene and said predetermined expression profile for said second identified gene from a second sample which omits said drug; and
(c) comparing said first correlation with said second correlation to determine a change of correlation.

13. The method of claim 11, said cellular network having a predetermined number of interactions, further comprising:
(a) determining identified interactions having a p-value less than a bonferroni-corrected threshold;
(b) determining a number of interactions which involve a first identified gene;
(c) determining a number of identified interactions involving said first identified gene;
(d) assigning a value to said first identified gene based on said predetermined number of interactions, said determined number of interactions which involve said first gene, said identified interactions, said determined number of identified interactions involving said first gene, and said determined identified interactions having a p-value less than a bonferroni-corrected threshold
(e) determining a number of interactions which involve a second identified gene;
(f) determining a number of identified interactions involving said second identified gene;
(g) assigning a value to said second identified gene based on said predetermined number of interactions, said determined number of interactions which involve said second gene, said identified interactions, said determined number of identified interactions involving said second gene, and said determined identified interactions having a p-value less than a bonferroni-corrected threshold; and
(h) ranking said first gene and said second gene based on said first gene value and said second gene value.

14. The method of claim 11, further comprising:
(a) determining a first correlation between a predetermined expression profile for a first identified gene and a predetermined expression profile for an identified gene that is not said first identified gene from a sample which includes said drug;
(b) determining a second correlation between said predetermined expression profile for said first identified gene and said predetermined expression profile for said identified gene that is not said first identified gene from a second sample which omits said drug;
(c) assigning a value to said first identified gene based on said first correlation involving said first gene, said second correlation involving said first gene, and said identified interactions involving said first gene;
(d) determining a first correlation between a predetermined expression profile for a second identified gene and a predetermined expression profile for an identified gene that is not said second identified gene from a sample which includes said drug;
(e) determining a second correlation between said predetermined expression profile for said second identified gene and said predetermined expression profile for said identified gene that is not said second identified gene from a second sample which omits said drug;
(f) assigning a value to said second identified gene based on said first correlation involving said second gene, said second correlation involving said second gene, and said identified interactions involving said second gene; and
(g) ranking said first gene and said second gene based on said first gene value and said second gene value.

15. The method of claim 11, further comprising identifying at least one said identified gene having a high ranking score.

16. The method of claim 11, said cellular network comprising protein-protein interactions, protein-DNA interactions and modulated interactions.

17. A system for predicting at least one phenotypically relevant gene involved in one or more interactions affected by a phenotype from a cellular network of interactions, comprising
(a) at least one processor, and
(b) a computer readable medium coupled to the at least one processor, having instructions which when executed cause the at least one processor to:
(i) identify one or more interactions affected by said phenotype
(ii) identify at least two genes involved in said identified interactions;
(iii) rank each of said identified genes based on said identified interactions; and
(iv) predict said at least one phenotypically relevant gene based on said ranking.

18. The system of claim 17, wherein said computer readable medium having further instructions which when executed cause the at least one processor to:
(a) determining a first correlation between a predetermined expression profile for a first identified gene and a predetermined expression profile for a second identified gene from a sample which includes said phenotype;
(b) determining a second correlation between said predetermined expression profile for said first identified gene and said predetermined expression profile for said second identified gene from a second sample which omits said phenotype; and
(c) comparing said first correlation with said second correlation to determine a change of correlation.

19. The system of claim 17, said cellular network having a predetermined number of interactions, wherein said computer readable medium having further instructions which when executed cause the at least one processor to:
(a) determining identified interactions having a p-value less than a bonferroni-corrected threshold;
(b) determining a number of interactions which involve a first identified gene;
(c) determining a number of identified interactions involving said first identified gene;
(d) assigning a value to said first identified gene based on said predetermined number of interactions, said determined number of interactions which involve said first gene, said identified interactions, said determined number of identified interactions involving said first gene, and said determined identified interactions having a p-value less than a bonferroni-corrected threshold;
(e) determining a number of interactions which involve a second identified gene;
(f) determining a number of identified interactions involving said second identified gene;
(g) assigning a value to said second identified gene based on said predetermined number of interactions, said determined number of interactions which involve said second gene, said identified interactions, said determined number of identified interactions involving said second gene, and said determined identified interactions having a p-value less than a bonferroni-corrected threshold; and
(h) ranking said first gene and said second gene based on said first gene value and said second gene value.

20. The system of claim 17, wherein said computer readable medium having further instructions which when executed cause the at least one processor to:
(a) determining a first correlation between a predetermined expression profile for a first identified gene and a predetermined expression profile for an identified gene that is not said first identified gene from a sample which includes said phenotype;
(b) determining a second correlation between said predetermined expression profile for said first identified gene and said predetermined expression profile for said identified gene that is not said first identified gene from a second sample which omits said phenotype;
(c) assigning a value to said first identified gene based on said first correlation involving said first gene, said second correlation involving said first gene, and said identified interactions involving said first gene;
(d) determining a first correlation between a predetermined expression profile for a second identified gene and a predetermined expression profile for an identified gene that is not said second identified gene from a sample which includes said phenotype;
(e) determining a second correlation between said predetermined expression profile for said second identified gene and said predetermined expression profile for said identified gene that is not said second identified gene from a second sample which omits said phenotype;
(f) assigning a value to said second identified gene based on said first correlation involving said second gene, said second correlation involving said second gene, and said identified interactions involving said second gene; and
(g) ranking said first gene and said second gene based on said first gene value and said second gene value.
